(19) United States
(12) Patent Application Publication
(10) Pub. No.: US 2023/0012470 A9
(43) Pub. Date: Jan. 12, 2023

(54) SYSTEM AND METHOD FOR DETECTING A ROADBLOCK ZONE

(71) Applicant: HERE Global B.V., Eindhoven (NL)

(72) Inventors: Zhenhua ZHANG, Chicago, IL (US); Leon STENNETH, Chicago, IL (US)

(21) Appl. No.: 16/950,527

(22) Filed: Nov. 17, 2020

Related U.S. Application Data
(60) Provisional application No. 63/080,451, filed on Sep. 18, 2020.

(51) Int. Cl. G01C 21/30; G01C 21/34; G08G 1/0968

(52) U.S. Cl. CPC G01C 21/30; G01C 21/3415; G08G 1/096822; G08G 1/096827

(57) ABSTRACT

The disclosure provides a method, a system, and a computer program product in accordance with at least one example embodiment for detecting a roadblock zone. The method comprises receiving one or more road object observations, determining a map-matched link based on the received one or more road object observations, and calculating, at one or more locations associated with the map-matched link, heading difference data associated with a difference between a heading of each road object observation of the one or more road object observations and a heading of the map-matched link. The method further comprises identifying a set of locations from the one or more locations associated with the map-matched link where the heading difference data is more than a first predetermined threshold for each location in the set of locations and detecting the roadblock zone on the map-matched link based on the identified set of locations.

### RELATED APPLICATION

This application claims priority from U.S. Provisional Application Ser. No. 63/080,451, entitled “SYSTEM AND METHOD FOR DETECTING A ROADBLOCK ZONE,” filed on Sep. 18, 2020, the contents of which are hereby incorporated herein in their entirety by this reference.

### TECHNOLOGICAL FIELD

The present disclosure generally relates to a field of maps and traffic event detection, and more particularly relates to a system, a method, and a computer program product for detecting a roadblock zone.

### BACKGROUND

A roadblock zone is an area on a road, where traversing of traffic may be blocked. The roadblock zone may result in halting or hindering free flow of traffic. The roadblock zone may occur due to a number of reasons such as roadwork constructions, an accident on the road, or the likes. Therefore, the roadblock zone may involve lane closures, detours, moving equipment used for roadwork, or the likes. The roadblock zones can be dangerous places for users of vehicles. Therefore, the users should be warned about the roadblock zones well in time to prevent occurrence of hazardous incidents. However, when the users (or autonomous vehicles) are not notified about the roadblock zones in due time, they would be unable to take accurate navigation decisions, such as changing the travel route to avoid passing the roadblock zone. Because the changed driving conditions at the roadblock zone may cause an unexpected increase in travel time for the vehicles passing such a roadblock zone, it also leads to increased inconvenience and may be at times frustrating for the users.

Thus, effective ways to deal with the problems described above are needed to provide safe and accurate navigation services.

### SUMMARY

With recent advancement is navigation systems, the current navigation systems may identify roadblock sites and may notify the user. However, determining start and end offset of the roadblock zone is still difficult. Therefore, approximate coverage of the roadblock zone on a particular link cannot be accurately determined. Currently, the roadblock zone may be updated in a map database as a point. The point representing the roadblock zone on a map may not be suitable for autonomous vehicles. Because, the autonomous vehicles may require information such as start of the roadblock zone, end of the roadblock zone, a set of links/lanes associated with the roadblock zone between the start and end, or the likes.

The navigation systems for detecting the roadblock zones discussed above need to be improved to determine the roadblock zone accurately and further determine information associated with the roadblock zone such as the start and end offset of the roadblock zone in order to provide an estimate of an area on a link affected by the roadblock zone. The lack of the information associated with the roadblock zone in the current navigation systems may lead to misinformed navigation decision making problem and may result in accidents.

Accordingly, there is a need of a system that may detect a roadblock zone on a link. A system, a method, and a computer program product are provided in accordance with an example embodiment described herein for detecting the roadblock zone.

Embodiments of the present invention provide a system for detecting the roadblock zone. The system comprises a memory configured to store computer executable instructions and one or more processors configured to execute the instructions to receive one or more road object observations, determine a map-matched link based on the received one or more road object observations, and calculate, at one or more locations associated with the map-matched link, heading difference data associated with a difference between a heading of each road object observation of the one or more road object observations and a heading of the map-matched link. The one or more processors are further configured to identify a set of locations from the one or more locations associated with the map-matched link where the heading difference data is more than a first predetermined threshold for each location in the set of locations and detect the roadblock zone on the map-matched link based on the identified set of locations.

According to some example embodiments, to calculate the heading difference data, the one or more processors are further configured to execute the stored instructions to determine a plurality of sub-links associated with the map-matched link, wherein each sub-link is of a predetermined length; and calculate the heading difference data for each road object observation of the one or more road object observations and each sub-link of the plurality of sub-links.

According to some example embodiments, the one or more processors are further configured to execute the stored instructions to determine the plurality of sub-links associated with the map-matched link within the set of locations.

According to some example embodiments, to detect the roadblock zone on the map-matched link, the one or more processors are configured to execute the stored instructions to calculate, for each sub-link of the plurality of sub-links, a ratio of: a first number of road object observations with the heading difference data greater than the first predetermined threshold and a second number of total road object observations associated with the sub-link, identify a set of sub-links from the plurality of sub-links where the ratio is greater than a second predetermined threshold, and determine a starting location of the roadblock zone and an ending location of the roadblock zone based on the set of sub-links.

According to some example embodiments, each sub-link of the plurality of sub-links may be formed by a plurality of shape points, and where the plurality of shape points indicates curvatures associated with the map-matched link. Further, each shape point of the plurality of shape points may be obtained from a map database.

According to some example embodiments, the one or more processor is further configured to execute the stored instructions to determine at least one proximate link based on the road object observations, wherein the at least one proximate link is in proximity of the map-matched link, and where a traffic on the map-matched link merges with a traffic on the at least one proximate link at the set of locations where the heading difference data is more than the first predetermined threshold. Further, the at least one proximate link comprises a link parallel to the map-matched link.

According to some example embodiments, the one or more processors is further configured to execute the stored instructions to update a map database based on the detected roadblock zone.

Embodiments of the disclosure provide a method for detecting roadblock zone. The method comprising receiving one or more road object observations, determining a map-matched link based on the received one or more road object observations, calculating, at one or more locations associated with the map-matched link, heading difference data associated with a difference between a heading of each road object observation of the plurality of road object observations and a heading of the map-matched link. The method further comprising identifying a set of locations from the one or more locations associated with the map-matched link where the heading difference data is more than a first predetermined threshold for each location in the set of locations, and detecting the roadblock zone on the map-matched link based on the identified set of locations.

Embodiments of the disclosure provide a computer programmable product for detecting a roadblock zone. The computer programmable product comprising a non-transitory computer readable medium having stored thereon computer executable instructions which when executed by one or more processors, cause the one or more processors to detect the roadblock zone, the instructions comprising: receiving one or more road object observations, determining a map-matched link based on the received one or more road object observations, calculating, at one or more locations associated with the map-matched link, heading difference data associated with a difference between a heading of each road object observation of the plurality of road object observations and a heading of the map-matched link. The instructions further comprising identifying a set of locations from the one or more locations associated with the map-matched link where the heading difference data is more than a first predetermined threshold for each location in the set of locations, and detecting the roadblock zone on the map-matched link based on the identified set of locations.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment of a system for detecting a roadblock zone, in accordance with an example embodiment;

FIG. 2 illustrates a block diagram of the system for detecting the roadblock zone, in accordance with an example embodiment;

FIG. 3A illustrates an exemplary satellite view of a chicane on a four-lane highway, in accordance with an example embodiment;

FIG. 3B illustrates different locations of the one or more vehicles while traversing between two chicane locations, in accordance with an example embodiment;

FIG. 4 illustrates a plurality of sub-links associated with the first link and heading differences between heading of each sub-link and the one or more road object observations associated with the corresponding sub-link; and

FIG. 5 illustrates a flow diagram of a method for detecting the roadblock zone, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, system and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause a system to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “chicane” may be used to refer to locations on a link where there is a diversion of traffic on the link towards another link.

The term “road object” may be used to refer to road and traffic signs, pylons, traffic cones, guardrails, diversion signs or the likes.

The term “link” may be used to refer to any connecting pathway including but not limited to a lane, a road, an aisle, an alley or the like.

The term “heading” may be used to refer to a direction in which a vehicle is travelling or a direction in which a link directs traffic to traverse.

The term “autonomous guided vehicle” may be used to refer to any vehicle having autonomous driving capabilities at least in some conditions. An autonomous guided vehicle, as used throughout this disclosure, may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### End of Definitions

A method, a system, and a computer program product may be provided for detecting a roadblock zone on a link, where travelling of the vehicles on the link may be blocked due to the roadblock zone. In order to detect the roadblock zone, the system may initially receive one or more road object observations. Based on the one or more road object observations, a map-matched link may be determined. Further, the system may obtain headings of the one or more road objects traversing the map-matched link and a heading of the map-matched link itself. The system may then determine, at one or more locations on the map-matched link, heading difference data between the heading of the one or more road objects traversing the map-matched link and the heading of the map-matched link. The heading difference data obtained at the one or more locations may be compared with a first predetermined threshold to identify a set of locations from the one or more locations where the heading difference data is more than the first predetermined threshold.

The set of locations where the heading difference data is more than the first predetermined threshold indicates presence of chicanes at the set of location. In order to accurately determine whether the chicane is present at the set of locations, the system determines, at these set of locations, a ratio of number of road object observations greater than the first predetermined threshold and the total number of road object observations. The locations where the ratio is more than a second predetermined threshold represents chicane locations. The system may then cluster such chicane locations to determine the roadblock zone on the map-matched link. The system may further determine start and end offset of the roadblock zone based on the chicane locations.

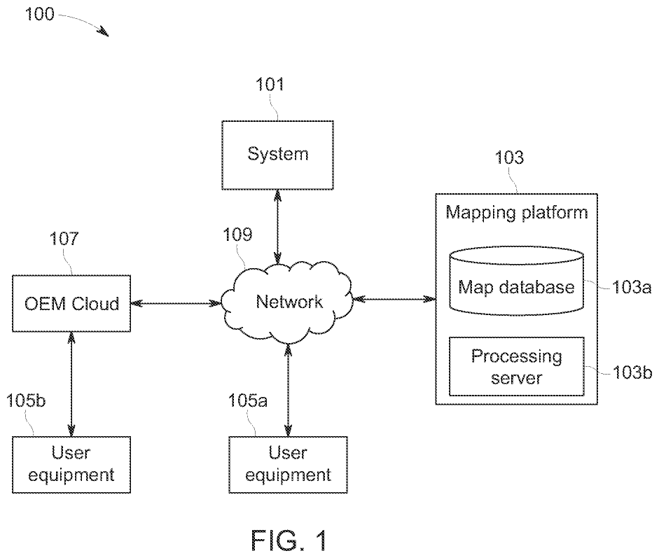

FIG. 1 illustrates a schematic diagram of a network environment 100 of a system 101 for detecting a roadblock zone, in accordance with an example embodiment. The system 101 may be communicatively coupled to a mapping platform 103, a user equipment 105a and an OEM (Original Equipment Manufacturer) cloud 107 connected to a user equipment 105b, via a network 109. The components described in the network environment 100 may be further broken down into more than one component and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud based service or a cloud based platform. As such, the system 101 may be configured to operate outside the user equipment 105a and/or 105b. However, in some example embodiments, the system 101 may be embodied within one or both of user equipment 105a and 105b, for example as part of an in-vehicle navigation system. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle to detect the roadblock zone. Further, in one embodiment, the system 101 may be a standalone unit configured to detect the roadblock zone for the autonomous vehicle. Alternatively, the system 101 may be coupled with an external device such as the autonomous vehicle.

The mapping platform 103 may comprise a map database 103a for storing map data and a processing server 103b. The map database 103a may store node data, road segment data, link data, point of interest (POI) data, link identification information, heading value records or the like. The map database 103a may also store cartographic data, routing data, and/or maneuvering data. Also, the map database 103a further includes speed limit data of each lane, cartographic data, routing data, and/or maneuvering data. Additionally, the map database 103a may be updated dynamically to cumulate real time traffic conditions. The real time traffic conditions may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. The real time traffic conditions update the autonomous vehicle on slow moving traffic, lane blockages, under construction road, freeway, right of way, and the like. In one embodiment, the map database 103a may further store historical traffic data that includes travel times, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 103a may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the user equipment 105a and/or 105b. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 105a and/or 105b to provide navigation and/or map-related functions. For example, the map database 103a may be used with the user equipment 105a and/or 105b to provide an end user with navigation features. In such a case, the map database 103a may be downloaded or stored locally (cached) on the user equipment 105.

The processing server 103b may comprise processing means and communication means. For example, the processing means may comprise one or more processors configured to process requests received from the user equipment 105a, 105b. The processing means may fetch map data from the map database 103a and transmit the same to the user equipment 105 via OEM cloud 109 in a format suitable for use by the one or both of the user equipment 105a and/or 105b. In one or more example embodiments, the mapping platform 103 may periodically communicate with the user equipment 105a, 105b via the processing server 103b to update a local cache of the map data stored on the user equipment 105a, 105b. Accordingly, in some example embodiments, the map data may also be stored on the user equipment 105a, 105b and may be updated based on periodic communication with the mapping platform 103.

In some example embodiments, the user equipment 105a, 105b may be any user accessible device such as a mobile phone, a smartphone, a portable computer, and the like that is portable in itself or as a part of another portable/mobile object such as a vehicle. The user equipment 105a, 105b may comprise a processor, a memory and a communication interface. The processor, the memory and the communication interface may be communicatively coupled to each other. In some example embodiments, the user equipment 105a, 105b may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 105a, 105b may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 105a, 105b. Additional, different, or fewer components may be provided. For example, the user equipment 105a, 105b may be configured to execute and run mobile applications such as a messaging application, a browser application, a navigation application, and the like. At least one user equipment such as user equipment 105b may be directly coupled to the system 101 via the network 109. For example, the user equipment 105b may be a dedicated vehicle (or a part thereof) for gathering data for development of the map data in the database 103a. In some example embodiments, at least one user equipment such as the user equipment 105b may be coupled to the system 101 via the OEM cloud 107 and the network 109. For example, the user equipment 105b may be a consumer vehicle (or a part thereof) and may be a beneficiary of the services provided by the system 101. In some example embodiments, one or more of the user equipment 105a and 105b may serve the dual purpose of a data gatherer and a beneficiary device. The user equipment 105a or 105b may be configured to capture sensor data associated with a road which the user equipment 105a, 105b may be traversing. The sensor data may for example be image data of road objects, road signs, or the surroundings (for example buildings). The sensor data may refer to sensor data collected from a sensor unit in the user equipment 105a and/or user equipment 105b. In accordance with an embodiment, the sensor data may refer to the data captured by the vehicle using sensors.

The network 109 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 109 is coupled directly or indirectly to the user equipment 105b via OEM cloud 107. In an example embodiment, the system may be integrated in the user equipment 105b. In an example, the mapping platform 103 may be integrated into a single platform to provide a suite of mapping and navigation related applications for OEM devices, such as the user devices and system 101. The system 101 may be configured to interface with the mapping platform 103 over the network 109. Thus, the mapping platform 103 may enable provision of cloud-based services for the system 101, such as, storing the lane marking observations in the OEM cloud 107 in batches or in real-time.

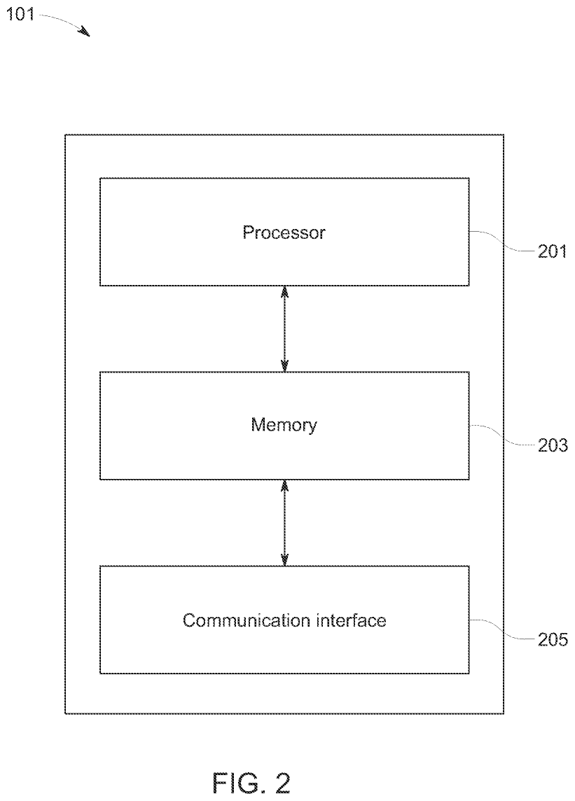

FIG. 2 illustrates a block diagram of the system 101 for detecting the roadblock zone, in accordance with an example embodiment. The system 101 may include a processing module such as at least one processor 201 (hereinafter, also referred to as “processor 201”), storage module such as at least one memory 203 (hereinafter, also referred to as “memory 203”), and a communication module such as at least one communication interface 205 (hereinafter, also referred to as “communication interface 205”). The processor 201 may retrieve computer program code instructions that may be stored in the memory 203 for execution of the computer program code instructions.

The processor 201 may be embodied in a number of different ways. For example, the processor 201 may be embodied as one or more of various hardware processing modules such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the user equipment 105a, 105b or any other component with which the system 101 may communicate. The communication interface 205 may be any module such as a device or circuitry embodied in either hardware or a combination of hardware and software that is configured to receive and/or transmit data to/from a communications device in communication with the user equipment 105a, 105b. In this regard, the communication interface 205 may include, for example, an antenna (or multiple antennae) and supporting hardware and/or software for enabling communications with a wireless communication network. Additionally or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

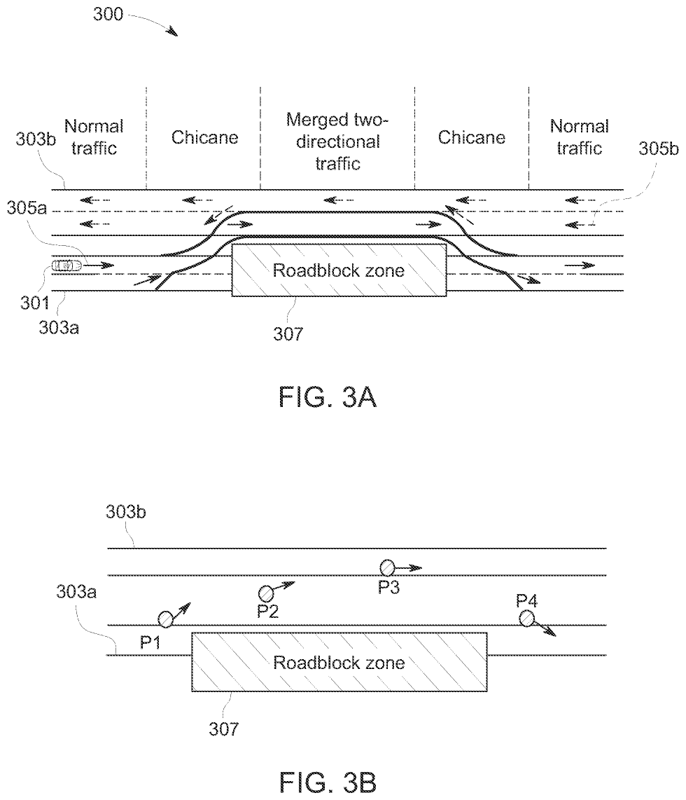

FIG. 3A illustrates an exemplary satellite or top-down view 300 of a chicane on a four-lane highway, in accordance with an example embodiment. A vehicle 301 (such as the user equipment 105a or 105b illustrated in FIG. 1) may be travelling on a first link 303a. There may be a second link 303b in proximity of the first link 303a. A heading 305a of the vehicle 301 travelling along a normal traffic on the first link 303a is same has a heading (not shown in FIG. 3A) of the first link 303a. Similarly, a heading 305b of a vehicle (not shown in FIG. 3A) travelling along a normal traffic on the second link 303b is same as a heading of the second link 303b. The normal traffic on the first link 303a travels in a direction opposite to that of the normal traffic of the second link 303b.

Further, there is a roadblock zone 307 on the first link 303a due to which normal traffic on first link 303a is diverted towards the second link 303b. The locations where the normal traffic is diverted away from the heading of the link are called chicane locations (or chicane). Due to the chicane, normal traffic on the first link 303a is merged with traffic on the second link 303b. The two-directional traffic remains merged on the second link 303b till the end of the roadblock zone 307 on the first link 303a. At the end of the roadblock zone 307, the traffic on the first link 303a that was merged with the traffic on the second link 303b is diverted again towards the first link 303a. The traffic again undergoes chicane and then merges with normal traffic flow on the first link 303a. The crisscross pattern of traffic diversions may thus be referred to as chicane for some embodiments as described herein.

One of the objectives of the present disclosure is to determine start and end offsets of the roadblock zone 307 and estimate coverage of the roadblock zone 307 affecting the normal traffic based on the start and the end offsets. Determining the start and the end offsets of the roadblock zone 307 and the estimated coverage of the roadblock zone 307 provides clearer view of the roadblock zone 307 on a map to a user travelling along the link 303a. Another objective of the present disclosure is to update the map database 103a accurately regarding the start and the end offsets of the roadblock zone 307 and changes in direction of traversing of the traffic on the first link 303a and the second link 303b due to the roadblock zone 307. The map database 103a updated accordingly may enable a new user or autonomous vehicles travelling along the link to take navigation decisions accordingly, such as avoiding the first link 303a altogether due to possible traffic jam because of the roadblock zone 307, delay in time of travel, controlling the speed of the vehicle based on the location of the chicane, or the likes. Further, in case of an autonomous driving vehicle, the updated map database may enable the autonomous driving vehicle to notify a driver regarding transition from autonomous driving mode to manual driving mode as the autonomous driving vehicle approaches the roadblock zone 307.

To achieve the one or more objectives mentioned above, the present disclosure proposes the system 101 for detecting the roadblock zone 307. The system 101 receives one or more road object observations. The road object observations may be received from multiple vehicles traversing on a link, for example the first link 303a. Each vehicle of the multiple vehicles may have one or more sensors to capture the road object observation and transmit the road object observations to the system 101. The system 101 determines a map matched link based on the one or more road object observations, in this case the first link 303a is the map-matched link. The system 101 may further determine at least one proximate link (the second link 303b) based on the one or more road object observations, where the at least one proximate link is in proximity of the map-matched link. The at least one proximate link may be parallel to the map-matched link. As illustrated in the FIG. 3A, the second link 303b in proximity of the first link 303a is parallel to the first link 303a. The system 101 further calculates, at one or more locations on the map-matched link, heading difference data between a heading of each road object observation of the one or more road object observations and a heading of the map-matched link. The heading difference data may comprise degrees of deviation of the heading of the vehicle with respect to the heading of the map-matched link.

The heading of road object observation represents a direction in which corresponding vehicle is pointed or traversing. Similarly, the heading of the map-matched link represents a direction in which traffic can traverse on the map-matched link. The system 101 further identifies a set of locations from the one or more locations associated with the map-matched link where the calculated heading difference data is more than a first predetermined threshold and detects the roadblock zone on the map-matched link based on the set of locations.

In an example embodiment, the first predetermined threshold may comprise a threshold difference between the heading of the road object observation and the heading of the map-matched link associated with the road object observation. The heading difference indicates a degree of deviation of the heading of the road object observation with respect to the heading of the map-matched link. Suppose, the first predetermined threshold is set to 80 degrees, then at the set of locations where the one or more road object observations have heading differences more than 80 degrees are determined to be deviating from the heading of the map-matched link. Therefore, the set of locations on the map-matched link where the heading difference is more than the first predetermined threshold may indicate presence of chicane. As can be observed in the FIG. 3A, there are two chicane locations on the first link 303a, where heading differences between the heading of each road object observation of the one or more road object observations and the heading of the map-matched link (first link 303a) is greater than the first predetermined threshold. However, the consideration of two locations in FIG. 3A is only for exemplary purpose. As may be well understood by a person of ordinary skill in the art, there may be numerous locations where such heading difference is observed, without deviating from the scope of the present invention.

In another embodiment, the system 101 may determine chicane locations on a link based on location of one or more vehicles on the link. The determination of the chicane based on the location of the one or more vehicles is provide below with respect to FIG. 3B.

In an example embodiment, coverage of the merged two-directional traffic on the second link 303b (as shown in the FIG. 3A) may also be determined along with potential chicane locations. Determination of the coverage of the merged two-directional traffic along with the potential chicane locations is described with reference to FIG. 3B in conjunction with FIG. 3A.

FIG. 3B illustrates different locations of the one or more vehicles while traversing between two chicane locations, in accordance with an example embodiment. In the FIG. 3B, the one or more vehicles (not shown in the FIG. 3B) traverse between two chicane locations i.e. from a first chicane location on the first link 303a to a second chicane location on the first link 303a. At the first chicane location the normal traffic in first direction on the first link 303a is diverted from the first link 303a and merged with traffic in a second direction on the second link 303b. These two-directional traffic remains merged until the second chicane location, where the normal traffic of the first link traverses back to the first link 303a. While traversing between the two chicane locations the one or more vehicles may pass through each of the locations P1, P2, P3, and P4 due to the roadblock zone 307.

Based on the location of the one or more vehicles present at any of the locations P1-P4 the system 101 may determine a closest link. For example, for the one or more vehicles when present at P1 and P4, the system 101 may determine the first link 303a as the closest link. Further, for the one or more vehicles when present at P2 and P3, the system 101 may determine the second link 303b as the closest link. Further, heading difference data between each vehicle of the one or more vehicles and heading of the closest link may be determined. For example, for each vehicle present at locations P1 and P4, heading difference data between heading of the vehicle and the heading of the first link 303a is determined, and for each vehicle present at the locations P2 and P3, heading difference data between heading of the vehicle and the second link 303b is determined.

A set of locations such as P1 and P4, where the heading difference data between the heading of the one or more vehicles and the heading of the first link 303a are more than the first predetermined threshold may be clustered together to indicate presence of chicane locations. Further, a set of location such as P2 and P3 where the heading difference data between the one or more vehicles and the heading of the second link is more than the first predetermined threshold may be clustered together to determine coverage of the merged two-directional traffic on the second link 303b (as illustrated in FIG. 3A). For example, if the first predetermined threshold is set to 70 degrees then the heading differences at locations P2 may be 150 degrees and the heading difference at location P3 may be 180 degrees as the heading of the one or more vehicles is exactly opposite to the heading of the second link 303b. A set of such locations where the heading differences are 180 degrees may be clustered together to determine the coverage of the merged two-directional traffic on the second link 303b

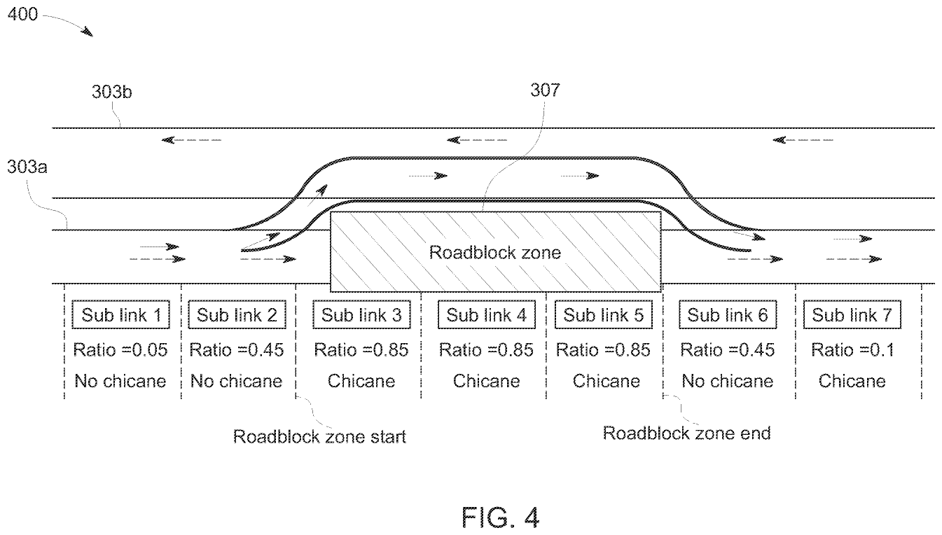

FIG. 4 illustrates a plurality of sub-links associated with the first link and a ratio for each sub-link of the plurality of sub-links, in accordance with an example embodiment. On reception of the one or more road object observations, the system 101 may determine a plurality of sub-links sub-link 1, sub-link 2, sub-link 3, sub-link 4, sub-link 5, sub-link 6, and sub-link 7 associated with the map-matched link (in this case, the first link 303a). Each sub-link is of a predetermined length. In an example embodiment, each sub-link may be 100 meters in length. In another example embodiment, each sub-link of the plurality of sub-links may be formed by a plurality of shape points, where the plurality of shape points indicates curvatures associated with the map-matched link. The plurality of shape points may be obtained from the map database 103a.

Further, the system 101 may calculate the heading difference data for each road object observation of the one or more road object observations and each sub-link of the plurality of sub-links. In an example embodiment, the plurality of sub-links associated with the map-matched link (in this case the first link 303a) may be determined within the set of locations, where the heading differences are more than the predetermined first threshold (i.e. chicane locations). For example, within two chicane locations on the first link 303a as indicated in the FIG. 3A.

Further, in order to determine which sub-links of the plurality of sub-links constitute the start and end of the roadblock zone 307, the system 101 calculates, for each sub-link of the plurality of sub-links, a ratio of: a first number of road object observations with the heading difference data greater than the first predetermined threshold and a second number of total road object observations associated with the sub-link. For example, out of the total 100 road object observations on a particular sub-link (for example, sub-link 2), if 45 road object observations are with the heading difference data more than the first predetermined threshold, then the ratio of number of road object observations with the heading difference data more than the first predetermined threshold (i.e. 45) and total number of road object observations (i.e. 100) will be 0.45 for that sub-link. The system 101 may further identify a set of sub-links from the plurality of sub-links sub-link 1 to sub-link 7, where the ratio is greater than a second predetermined threshold and determine a starting location of the roadblock zone 307 and an ending location of the road block zone 307 based on the identified set of sub-links.

For example, suppose the second predetermined threshold is set to 0.6. Further, suppose the ratio determined at the sub-link 1 is 0.05, at the sub-link 2 is 0.45, at the sub-link 3 is 0.85, at the sub-link 4 is 0.85, at the sub-link 5 is 0.85, at the sub-link 6 is 0.45, and at the sub-link 7 is 0.1. The system 101 may cluster together the sub-links such as sub-link 3, sub-link 4, and sub-link 5 to determine the starting location and the ending location of the roadblock zone 307 which may be used to estimate the coverage of the roadblock zone 307. In another embodiment, the system 101 may start determining the plurality of sub-links of the predetermined length from the location on the map-matched link where the heading difference is determined to be more than the first predetermined threshold. Further, the ratio may be determined for the sub-links with heading difference is more than the first predetermined threshold.

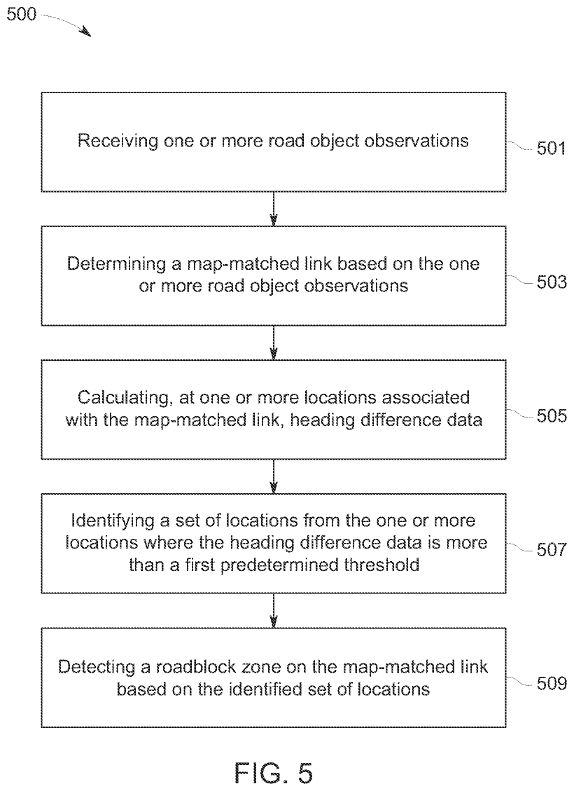

FIG. 5 illustrates a flow diagram of a method 500 for detecting the roadblock zone, in accordance with an example embodiment. The method 500 begins at step 501, when one or more road object observations may be received by the system 101. The road objects may be a traffic sign, a pylon, or the likes. The road object observations may be received from one or more vehicles, where the one or more vehicles may comprise sensors that may capture the road object observation and report the road object observations to the system 101.

At step 503, a map-matched link may be determined based on the received one or more road object observations. The map-matched link is a link on which the one or more vehicles are traversing. Further, at least one link in proximity to the map-matched link may be determined based on the one or more road object observations. The at least one proximate link may comprise a link parallel to the map-matched link.

At step 505, heading difference data associated with a difference between a heading of each road object observation of the one or more road object observations and a heading of the map-matched link may be calculated at one or more locations associated with the map-matched link. The heading difference indicates a degree of deviation of the heading of the road object observation with respect to the heading of the map-matched link.

At step 507, a set of locations may be identified from the one or more locations associated with the map-matched link where the heading difference data is more than a first predetermined threshold for each location in the set of locations. The identified set of locations may indicate presence of chicane on the map-matched link. The indications of the presence of chicane may indicate presence of roadblock zone near the set of locations.

At step 509, the roadblock zone may be detected on the map-matched link based on the identified set of locations. To that end, the method 500 may include determining a plurality of sub-links on the map-matched link, where each sub-link may be formed by a plurality of shape points. The plurality of shape points indicates curvature of the map-matched link, where the plurality of shape points may be obtained from the map databases 103a. The method may further include calculating for each sub-link of the plurality of sub-links, a ratio of a first number of road object observations with the heading difference data greater than the first predetermined threshold and a second number of total road object observations associated with the sub-link. Further, a set of sub-links from the plurality of sub-links where the ratio is greater than a second predetermined threshold may be identified. Based on the identified set of sub-links, a starting location of the roadblock zone and an ending location of the roadblock zone may be determined. The determined roadblock zone on the map-matched link, and corresponding change in direction of travel on the map-matched link may be updated on the map-database 103a.

The method 500 may be implemented using corresponding circuitry. For example, the method 500 may be implemented by a system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 500.

In an example embodiment, a system for performing the method 500 of FIG. 5 above may comprise a processor (e.g. the processor 201) configured to perform some or each of the operations of the method 500 of FIG. 5 described previously. The processor may, for example, be configured to perform the operations (501-509) by performing hardware implemented logical functions, executing stored instructions, or executing algorithms for performing each of the operations. Alternatively, the system may comprise modules for performing each of the operations described above. In this regard, according to an example embodiment, examples of modules for performing operations (501-509) may comprise, for example, the processor 201 which may be implemented in the system 101 and/or a device or circuit for executing instructions or executing an algorithm for processing information as described above.

In this way, example embodiments of the invention results in detecting one or more roadblock zones on a link, changes in direction of travel of traffic on the link due to the one or more roadblock zones, and updating the map database 103a accordingly. In order to achieve this, initially a set of locations on a map-matched link is identified where heading difference data is more than a first predetermined threshold. The set of locations indicates a possible presence of chicane. Further, to confirm the presence of chicane at the identified set of locations, a ratio of a first number of road object observations with the heading difference data greater than the first predetermined threshold and a second number of total road object observations is calculated at the identified locations. The set of locations where the ratio is greater than a second predetermined threshold are used to determine the one or more roadblock zones, where each roadblock zone may comprise start and end locations of the roadblock zones, coverage of the roadblock zone. The map database 103a updated with the information associated with the one or more roadblock zones may provide an end user with accurate and reliable navigation assistance. Therefore, embodiments of the present disclosure may provide improvements in the map database and/or the navigation assistance by detecting the one or more roadblock zones.

Many modifications and other embodiments of the inventions set forth herein will come to mind to one skilled in the art to which these inventions pertain having the benefit of the teachings presented in the foregoing descriptions and the associated drawings. It is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system for detecting a roadblock zone, the system comprising:
a memory configured to store instructions; and
one or more processors configured to execute the stored instructions to:
receive one or more road object observations;
determine a map-matched link based on the received one or more road object observations;
calculate, at one or more locations associated with the map-matched link, heading difference data associated with a difference between a heading of each road object observation of the one or more road object observations and a heading of the map-matched link;
identify a set of locations from the one or more locations associated with the map-matched link where the heading difference data is more than a first predetermined threshold for each location in the set of locations; and
detect the roadblock zone on the map-matched link based on the identified set of locations.

2. The system of claim 1, wherein to calculate the heading difference data, the one or more processors are further configured to execute the stored instructions to:
determine a plurality of sub-links associated with the map-matched link, wherein each sub-link is of a predetermined length; and
calculate the heading difference data for each road object observation of the one or more road object observations and each sub-link of the plurality of sub-links.

3. The system of claim 2, wherein the one or more processors are further configured to execute the stored instructions to determine the plurality of sub-links associated with the map-matched link within the set of locations.

4. The system of claim 3, wherein to detect the roadblock zone on the map-matched link, the one or more processors are configured to execute the stored instructions to:
calculate, for each sub-link of the plurality of sub-links, a ratio of: a first number of road object observations with the heading difference data greater than the first predetermined threshold and a second number of total road object observations associated with the sub-link:
identify a set of sub-links from the plurality of sub-links where the ratio is greater than a second predetermined threshold; and
determine a starting location of the roadblock zone and an ending location of the roadblock zone based on the set of sub-links.

5. The system of claim 1, wherein the one or more processor is further configured to execute the stored instructions to:
determine at least one proximate link based on the road object observations, wherein the at least one proximate link is in proximity of the map-matched link, and
wherein a traffic on the map-matched link merges with a traffic on the at least one proximate link at the set of locations where the heading difference data is more than the first predetermined threshold.

6. The system of claim 5, wherein the at least one proximate link comprises a link parallel to the map-matched link.

7. The system of claim 1, wherein the one or more processors is further configured to execute the stored instructions to update a map database based on the detected roadblock zone.

8. A method for detecting a roadblock zone, the method comprising:
receiving one or more road object observations:
determining a map-matched link based on the received one or more road object observations:
calculating, at one or more locations associated with the map-matched link, heading difference data associated with a difference between a heading of each road object observation of the plurality of road object observations and a heading of the map-matched link:
identifying a set of locations from the one or more locations associated with the map-matched link where the heading difference data is more than a first predetermined threshold for each location in the set of locations: and
detecting the roadblock zone on the map-matched link based on the identified set of locations.

9. The method of claim 8, wherein calculating the heading difference data further comprises:
determining a plurality of sub-links associated with the map-matched link, wherein each sub-link is of a predetermined length; and
calculating the heading difference data for each road object observation of the one or more road object observations and each sub-link of the plurality of sub-links.

10. The method of claim 9, further comprising determining the plurality of sub-links associated with the map-matched link within the set of locations.

11. The method of claim 10, wherein detecting the roadblock zone on the map-matched link further comprises:
calculating, for each sub-link of the plurality of sub-links, a ratio of: a first number of road object observations with the heading difference data greater than the first predetermined threshold and a second number of total road object observations associated with the sub-link;
identifying a set of sub-links from the plurality of sub-links where the ratio is greater than a second predetermined threshold; and
determining a starting location of the roadblock zone and an ending location of the roadblock zone based on the set of sub-links.

12. The method of claim 8, wherein the method further comprises
determining at least one proximate link based on the road object observations, wherein the at least one proximate link is in proximity of the map-matched link, and
wherein a traffic on the map-matched link merges with a traffic on the at least one proximate link at the set of locations where the heading difference data is more than the first predetermined threshold.

13. The system of claim 12, wherein the at least one proximate link comprises a link parallel to the map-matched link.

14. The method of claim 8, further comprising updating a map database based on the detected roadblock zone.

15. A computer programmable product comprising a non-transitory computer readable medium having stored thereon computer executable instructions which when executed by one or more processors, cause the one or more processors to detect a roadblock zone, the instructions comprising:
receiving one or more object observations;
determining a map-matched link based on the received one or more road object observations;
calculating, at one or more locations associated with the map-matched link, heading difference data associated with a difference between a heading of each road object observation of the one or more road object observations and a heading of the map-matched link;
identifying a set of locations from the one or more locations associated with the map- matched link where the heading difference data is more than a first predetermined threshold for each location in the set of locations; and
detecting the roadblock zone on the map-matched link based on the identified set of locations.

16. The computer program product of claim 15, wherein for calculating the heading difference data, the instructions further comprise:
determining a plurality of sub-links associated with the map-matched link, wherein each sub-link is of a predetermined length, and
calculating the heading difference data for each road object observation of the one or more road object observations and each sub-link of the plurality of sub-links.

17. The computer program product of claim 16, wherein the instructions further comprise determining the plurality of sub-links associated with the map-matched link within the set of locations.

18. The computer program product of claim 17, wherein for detecting the roadblock zone on the map-matched link the instructions further comprise:
calculating, for each sub-link of the plurality of sub-links, a ratio of: a first number of road object observations with the heading difference data greater than the first predetermined threshold and a second number of total road object observ ations associated with the sub-link;
identifying a set of sub-links from the plurality of sub-links where the ratio is greater than a second predetermined threshold; and
determining a starting location of the roadblock zone and an ending location of the roadblock zone based on the set of sub-link.

19. The computer program product of claim 15, wherein the instructions further comprise:
determining at least one proximate link based on the road object observations, wherein the at least one proximate link is in proximity of the map-matched link, and
wherein traffic on the map-matched link merges with traffic on the at least one proximate link at the set of locations where the heading difference data is more than the first predetermined threshold.

20. The computer program product of claim 19,
wherein the at least one proximate link comprises a link parallel to the map-matched link, and
wherein the instructions further comprise updating a map database based on the detected roadblock zone.
